(19) United States
(12) Patent Application Publication
(10) Pub. No.: US 2012/0242449 A1
(43) Pub. Date: Sep. 27, 2012

(54) Fusible Cut-Out Link And Overcurrent Protection Device

(76) Inventors: Markus Faltermeier, Regensburg (DE); Thomas Lohr, Ihrlerstein (DE)

(21) Appl. No.: 13/419,896

(22) Filed: Mar. 14, 2012

(30) Foreign Application Priority Data
Mar. 22, 2011 (DE) 10 2011 005 884.2

(51) Int. Cl. H01H 85/04

(52) U.S. Cl. 337/186

(57) ABSTRACT

The fusible cut-out link, e.g., for semiconductor fuses, may have a ceramic body filled with compacted sand. The ceramic body may have a volume reservoir embodied such that an increase in internal pressure in the ceramic body due to thermal expansion of the compacted sand causes the volume reservoir to release an additional volume in the ceramic body, thereby allowing the compacted sand to expand. In this manner, it may be possible to avoid or limit damage to the ceramic body due to stress fractures caused by the different rates of thermal expansion of the compacted sand and of the ceramic body as a result of an increase in temperature and the increase in internal pressure in the ceramic body associated therewith. The robustness of the fusible cut-out link may be significantly improved as a result.

### CROSS-REFERENCE TO RELATED APPLICATIONS

This application claims priority to DE Patent Application No. 10 2011 005 884.2 filed Mar. 22, 2011. The contents of which is incorporated herein by reference in its entirety.

### TECHNICAL FIELD

This disclosure relates to a fusible cut-out link—e.g., for semiconductor fuses—which has a ceramic body filled with compacted sand. The disclosure further relates to an overcurrent protection device having a fusible cut-out link of said type.

### BACKGROUND

A fusible cut-out is an overcurrent protection device which interrupts the electric circuit as a result of the melting of one or more fusible conductors when the intensity of the current exceeds a specific value over a specific period of time. The cut-out consists of an insulating body having two electrical terminals which are connected to each other in the interior of the insulating body by means of a fusible conductor. The fusible conductor is heated by the current flowing through it and melts if the relevant rated current of the fuse is significantly exceeded for a specific period of time. Ceramic is mostly used as the material for the insulating body on account of its good insulating effect.

In a sand-filled fusible cut-out link, the fusible conductor is surrounded by compacted quartz sand. The housing of the fuse link is formed by a ceramic body in which the compacted sand, the electrical terminals and the fusible conductor are accommodated or retained. In this arrangement the quartz sand acts as an arc quenching means: if the rated current of the fusible cut-out is significantly exceeded—due to a short-circuit for example—this leads to a response by the fusible cut-out in the course of which the fusible conductor initially melts and subsequently vaporizes due to the high temperature development. This results in the formation of an electrically conductive plasma via which the flow of current between the electrical terminals is initially maintained, producing an electric arc. As the metal vapor of the vaporized fusible conductor is precipitated on the surface of the quartz sand grains, the arc is cooled down again. Subsequently the resistance in the interior of the fuse link increases to such an extent that the arc is finally extinguished. The circuit that is to be protected by means of the fusible cut-out is interrupted as a result.

In sand-filled fusible cut-out links having a large volume of compacted sand, stresses are produced in the ceramic body due to the different coefficients of thermal expansion of the quartz sand on the one hand and of the ceramic body on the other, which may ultimately lead to the rupturing of the ceramic body. Commercially available fusible cut-out links counteract this problem by employing specialized, high-quality ceramics which are characterized for example by a higher aluminum oxide content. In addition to higher strength, ceramics of said type also have a greater coefficient of thermal expansion than comparable ceramics having a lower aluminum oxide content. Both properties—the higher strength and the higher coefficient of thermal expansion—mitigate the problem of damage to the ceramic body. Owing to their special high-quality properties, however, the ceramic materials that are considered suitable for this purpose are relatively expensive. Furthermore, in order to reduce the stresses in the ceramic body due to the thermal expansion of the compacted sand, fusible cut-out links are available in which a damping element is arranged along the inner circumference of the ceramic body between the ceramic body and the compacted sand. However, this arrangement has the disadvantage that the heat dissipation of the fusible cut-out link and consequently the tripping and disconnecting behavior of the fusible cut-out link are rendered significantly worse.

### SUMMARY

In one embodiment, a fusible cut-out link, in particular for semiconductor fuses, has a ceramic body filled with compacted sand, wherein the ceramic body has a volume reservoir which is embodied in such a way that if there is an increase in internal pressure in the ceramic body due to thermal expansion of the compacted sand, an additional volume in the ceramic body is released by the volume reservoir in order to allow the compacted sand to expand.

In a further embodiment, the volume reservoir is embodied at an internal wall of the ceramic body. In a further embodiment, the volume reservoir is separated from the compacted sand by means of a partition wall of the ceramic body, which partition wall is embodied such that it will fracture when a predefined internal pressure is reached, thereby releasing the additional volume to allow the compacted sand to expand in the ceramic body. In a further embodiment, the volume reservoir is filled with an air or gas mixture. In a further embodiment, the volume reservoir is filled with uncompacted sand. In a further embodiment, the volume reservoir is filled with an elastic material. In a further embodiment, the ceramic body can be produced by means of extrusion.

In another embodiment, an overcurrent protection device includes at least one fusible cut-out link having a ceramic body filled with compacted sand, wherein the ceramic body has a volume reservoir which is embodied in such a way that if there is an increase in internal pressure in the ceramic body due to thermal expansion of the compacted sand, an additional volume in the ceramic body is released by the volume reservoir in order to allow the compacted sand to expand

### BRIEF DESCRIPTION OF THE DRAWINGS

Example embodiments will be explained in more detail below with reference to figures, in which:

FIGS. 1A and 1B show a plan view and a perspective view, respectively, of an example fusible cut-out link according to a first example embodiment, and

FIGS. 2A and 2B show perspective views of another example fusible cut-out link according to a second example embodiment.

### DETAILED DESCRIPTION

Some embodiments provide a fusible cut-out link and an overcurrent protection device having such a fusible cut-out link which may provide an improved robustness while at the same time being easier and more cost-effective to produce.

In some embodiments, a fusible cut-out link, e.g., for semiconductor fuses, has a ceramic body filled with compacted sand. The ceramic body for its part has a volume reservoir which is embodied in such a way that if there is an increase in internal pressure in the ceramic body due to thermal expansion of the compacted sand, an additional volume in the ceramic body is released by the volume reservoir in order to allow the compacted sand to expand.

In some embodiments, the ceramic body and the compacted sand have different coefficients of thermal expansion, i.e. in the event of an increase in temperature the compacted sand expands to a greater extent than the ceramic body surrounding the compacted sand, which leads as the temperature increases to an increase in the internal pressure in the ceramic body and consequently to stresses in the ceramic body. Through the use of a volume reservoir which is integrated into the ceramic body and with the aid of which an additional volume is provided in the ceramic body if there is an increase in the internal pressure, which additional volume is available to allow further expansion of the compacted sand, the internal pressure arising in the ceramic body can be limited to a tolerable value. In this way the possibility of damage to the ceramic body due to stress fractures caused by the different rates of thermal expansion of the compacted sand and of the ceramic body may be avoided or reduced. The robustness of the fusible cut-out link may be significantly improved as a result.

Furthermore, in some embodiments, a ceramic having a lower aluminum oxide content can be used for producing the ceramic body. A ceramic of said type may be cheaper to produce and also easier to process, which as a result may significantly reduce he production costs of the fusible cut-out link. In designs intended for use in standard applications this allows a less complex ceramic to be used while maintaining the same performance; specialized designs for problematic application conditions for which even high-quality ceramics are not adequate can be realized by incorporating a supplementary body in the compacted sand.

In an advantageous development of the fusible cut-out link the volume reservoir may be embodied at an inner wall of the ceramic body. The ceramic body constitutes a housing of the fusible cut-out link, the interior of which is embodied to accommodate the compacted sand. By arranging the volume reservoir at an inner wall of the ceramic body—and hence in immediate proximity to the compacted sand—it may be ensured that the volume additionally released by the volume reservoir is instantly available for the expansion of the compacted sand.

In a further advantageous development of the fusible cut-out link the volume reservoir may be separated from the compacted sand by means of a partition wall of the ceramic body. In this case the partition wall is embodied such that it will fracture when a predefined internal pressure is reached, thereby releasing the additional volume to allow expansion of the compacted sand in the ceramic body.

Toward that end the partition wall may have a comparatively thin wall thickness which acts as a “predetermined breaking point” in the event of a pressure increase in the interior of the ceramic body—i.e., it fractures—as a result of which the volume reservoir partitioned off from the compacted sand until that time is released and is available for a further expansion of the compacted sand. In such an arrangement the ceramic body can also have a plurality of volume reservoirs separated off by means of partition walls. The partition walls can also have different wall thicknesses so that if there is a surge in the internal pressure they do not all disintegrate simultaneously, but one after another. In this way the additional volume can be released in a cascaded manner, i.e., in a plurality of portions, for further expansion of the compacted sand.

In another advantageous development of the fusible cut-out link the volume reservoir may be filled with an air or gas mixture. Filling the volume reservoir with air may provide a fusible cut-out link that is simple to implement and can be achieved at low cost. A gas mixture—including for example inert or sluggishly reacting, gases such as nitrogen or noble gases—can also be used instead of air.

In a further advantageous development of the fusible cut-out link the volume reservoir may be filled with uncompacted sand. In this way the additional volume provided by the volume reservoir can be limited to a low value without this at the same time adversely affecting the tripping precision of the fusible cut-out link. In order to maintain this precision, i.e., in order to determine the threshold value of the internal pressure as of which the additional volume is to be available as accurately as possible, a specific manufacturing precision of the ceramic body in terms of its geometry and its wall thickness may be required. The minimum wall thickness imposed by the manufacturing method may necessitate for its part a minimum size of volume reservoir, which is difficult to realize in the case of only a small additional volume. On the other hand, filling the volume reservoir with uncompacted sand permits only a small additional volume to be made available for further expansion of the compacted sand, even with the above-described, geometrically imposed minimum size of the volume reservoir, wherein the threshold value of the internal pressure as of which the additional volume is to be available can be predetermined with a relatively good degree of precision.

In another advantageous development of the fusible cut-out link the volume reservoir may be filled with an elastic material. Like the filling with uncompacted sand, filling the volume reservoir with an elastic material constitutes a suitable means of making only a limited additional volume available for further expansion of the compacted sand. At the same time filling the volume reservoir with an elastic material may provide the further advantage that no cavities will ensue in the compacted sand when the additional volume is provided. Instead, the further expansion of the compacted sand may be realized through a compression of the elastic body while the internal pressure remains virtually the same.

In a further advantageous development of the fusible cut-out link the ceramic body can be produced by extrusion. An extrusion method may provide a simple and extremely cost-effective means of manufacturing the ceramic body which may be suitable, e.g., for processing simple ceramic materials. High-quality ceramic materials, e.g., materials of such type having a high aluminum oxide content, may only be suitable to a degree for processing with the aid of an extrusion method or may even be totally unsuitable.

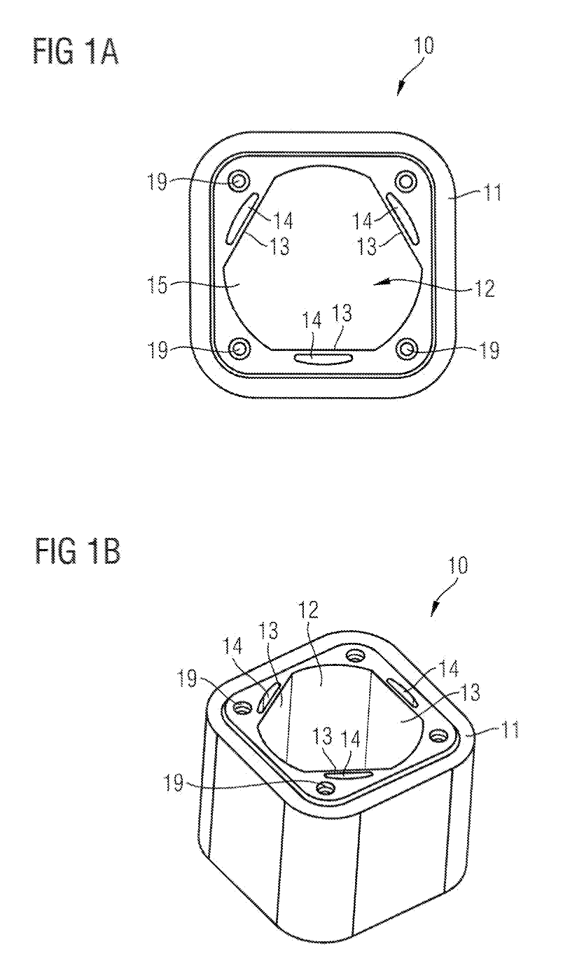

The overcurrent protection device according to certain embodiments may have at least one fusible cut-out link as described herein. FIGS. 1A and 1B show a first example embodiment of a fusible cut-out link 10. FIG. 1A shows a plan view, while FIG. 1B shows the fusible cut-out link 10 in a perspective view. The fusible cut-out link 10 has a ceramic body 11 in the form of a hollow tubular body at each of the two ends of which there is an opening 15. The internal space of the ceramic body 11 surrounded by the hollow tubular body serves essentially as a holding space 12 for accommodating compacted sand (not shown) which acts as a quenching agent for extinguishing an electric arc occurring when the fusible cut-out link 10 is tripped. A contact element (not shown) via which the fusible cut-out link 10 can be electrically contacted to an electric circuit that is to be protected can be arranged at each of the two openings 15 of the tubular ceramic body 11. The respective contact element may be centered and held in position relative to the ceramic body 11 with the aid in each case of a cover plate (not shown) which can be secured to the ceramic body by way of a plurality of boreholes 19 embodied in the ceramic body 11. The two cover plates also serve to seal the two openings 15 of the ceramic body 11 in a pressure-tight manner in a final assembled state. Generally disposed in the holding space 12 is what is termed a fusible conductor (not shown) which connects the two contact elements in the interior of the fusible cut-out link in an electrically conducting manner. In the final assembled state the fusible conductor may be surrounded by compacted sand, for example quartz sand, though for clarity of illustration reasons this is not shown in the figures.

In addition the ceramic body 11 may have a volume reservoir in the form of a plurality of chambers 14 embodied in the wall structure of the ceramic body 11 and separated by means of a partition wall 13 from the compacted sand. If the internal pressure in the interior of the ceramic body 11 exceeds a predefined threshold value—for example due to thermal expansion of the compacted sand during a tripping of the fusible cut-out link 10—the partition walls 13 collapse, as a result of which the chamber volume lying behind the partition walls 13 is available as an additional volume in the ceramic body to accommodate the expansion of the compacted sand.

With currents that are smaller than the rated current of the fusible cut-out link 10, only so much thermal power loss is converted in the fusible conductors as can be dissipated in the form of heat to the outside quickly by way of the sand, the ceramic body 11 and the contact elements. In this case the temperature of the fusible conductors does not rise above their melting point. On the other hand, if a current flows which lies in the overload range of the fusible cut-out link 10—due to a short-circuit for example—the temperature in the interior of the fusible cut-out link 10 will continue to climb steadily until the melting point of the fusible conductors is exceeded and the fusible conductors melt through. Because the liquefied conductor material still exhibits good electrically conducting properties, the current continues to flow by way of the molten mass until the latter vaporizes and an electric arc is produced. The extremely high temperatures occurring during this process cause the surrounding quartz sand to fuse, leading to a chemical reaction between the molten metal and the quartz sand. The reaction product resulting therefrom is a good insulator which finally interrupts the current flow.

A great deal of heat may be generated as a result of the electric arc being produced during the tripping of the fusible cut-out link 10, leading to an increase in the temperature of the compacted sand and consequently—due to thermal expansion—to an expansion of the compacted sand. Since the coefficient of thermal expansion of the compacted sand is generally greater than the coefficient of thermal expansion of the ceramic body 11 surrounding the compacted sand, this causes a sharp increase in the internal pressure in the ceramic body 11. In order to avoid damage to the ceramic body 1, such as stress fractures for example, the partition walls 13 which separate the chambers 14 from the compacted sand disintegrate as of a defined threshold value for the internal pressure. As a result thereof the volume enclosed by the chambers 14—which may be filled for example with an air or gas mixture, with uncompacted sand or with an elastic material—is released. Because the compacted sand can now expand into said volume, the internal pressure decreases once more to a value below the threshold value. Using an appropriate choice of the threshold value, damage to the ceramic body can thus be avoided or limited.

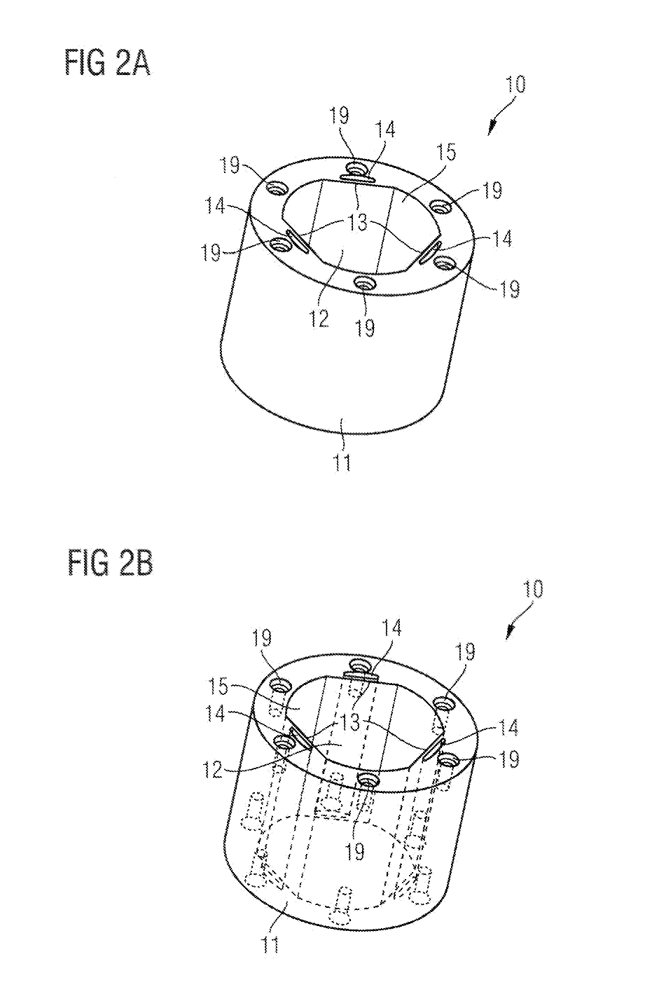

A second example embodiment of a fusible cut-out link is shown in two perspective views in FIGS. 2A and 2B. The fusible cut-out link 10 again has a ceramic body 11 which in this case is embodied as a hollow cylinder. In all other respects the ceramic body 11 of the second exemplary embodiment the structure and function may be similar to that of the ceramic body 11 of the first example embodiment shown in FIGS. 1A and 1B and discussed above.

FIG. 2B shows the ceramic body in a partially transparent view. It is made clear in this view that the chambers 14 and the partition walls 13 extend from end to end over the entire length of the hollow cylindrical ceramic body 11. Since otherwise the ceramic body 11 has no undercuts either, it can be produced—provided the ceramic material is suitable for this purpose—as a press-drawn molded part or by means of an extrusion process. A common feature of both these primary shaping methods is that the material to be molded may be pressed by a die or through a die plate to form its shape. Both production methods may be characterized by extremely low marginal costs and may be suitable, e.g., for mass production.

As an alternative to a hollow cylinder, other hollow shapes, for example hollow parallelepipeds or hollow prisms, can also be used for forming the ceramic body 11.

### LIST OF NUMBERED ELEMENTS IN THE DRAWINGS

10 Fusible cut-out link
11 Ceramic body
12 Holding space
13 Partition wall
14 Volume reservoir/chamber
15 Opening
19 Borehole

What is claimed is:

1. A fusible cut-out link for semiconductor fuses, comprising:
a ceramic body having a holding space filled with compacted sand, and
a volume reservoir formed in the ceramic body and configured such that an increase in internal pressure in the ceramic body due to thermal expansion of the compacted sand causes the volume reservoir to combine with the holding space in the ceramic body, thereby allowing the compacted sand in the holding space to expand into the volume reservoir.

2. The fusible cut-out link of claim 1, wherein the volume reservoir is formed in an internal wall of the ceramic body.

3. The fusible cut-out link of claim 1, wherein the volume reservoir is separated from the holding space by a partition wall of the ceramic body, the partition wall being configured to fracture in response to a predefined pressure, thereby combining the volume reservoir with the holding space such that the compacted sand is allowed expand into the volume reservoir.

4. The fusible cut-out link of claim 1, wherein the volume reservoir is filled with an air or gas mixture.

5. The fusible cut-out link of claim 1, wherein the volume reservoir is filled with uncompacted sand.

6. The fusible cut-out link of claim 1, wherein the volume reservoir is filled with an elastic material.

7. The fusible cut-out link of claim 1, wherein the ceramic body comprises an extruded structure.

8. The fusible cut-out link of claim 1, comprising multiple volume reservoirs formed around a circumference of the holding space of the ceramic body.

9. The fusible cut-out link of claim 8, comprising at least three volume reservoirs formed around a circumference of the holding space of the ceramic body.

10. The fusible cut-out link of claim 1, wherein both the holding space and the volume reservoir have a constant cross-section along an axial direction of the ceramic body.

11. An overcurrent protection device, comprising:
at least one fusible cut-out link, including:
a ceramic body having a holding space filled with compacted sand, and
a volume reservoir formed in the ceramic body and configured such that an increase in internal pressure in the ceramic body due to thermal expansion of the compacted sand causes the volume reservoir to combine with the holding space in the ceramic body, thereby allowing the compacted sand in the holding space to expand into the volume reservoir.

12. The overcurrent protection device of claim 11, wherein the volume reservoir is formed in an internal wall of the ceramic body.

13. The overcurrent protection device of claim 11, wherein the volume reservoir is separated from the holding space by a partition wall of the ceramic body, the partition wall being configured to fracture in response to a predefined pressure, thereby combining the volume reservoir with the holding space such that the compacted sand is allowed expand into the volume reservoir.

14. The overcurrent protection device of claim 11, wherein the volume reservoir is filled with an air or gas mixture.

15. The overcurrent protection device of claim 11, wherein the volume reservoir is filled with uncompacted sand.

16. The overcurrent protection device of claim 11, wherein the volume reservoir is filled with an elastic material.

17. The overcurrent protection device of claim 11, wherein the ceramic body comprises an extruded structure.

18. The overcurrent protection device of claim 11, wherein each fusible cut-out link includes multiple volume reservoirs formed around a circumference of the holding space of the ceramic body.

19. The overcurrent protection device of claim 18, wherein each fusible cut-out link includes at least three volume reservoirs formed around a circumference of the holding space of the ceramic body.

20. The overcurrent protection device of claim 11, wherein both the holding space and the volume reservoir have a constant cross-section along an axial direction of the ceramic body.
